(19) United States
(12) Patent Application Publication
(10) Pub. No.: US 2010/0254584 A1
(43) Pub. Date: Oct. 7, 2010

(54) AUTOMATED METHOD FOR ASSESSMENT OF TUMOR RESPONSE TO THERAPY WITH MULTI-PARAMETRIC MRI

(75) Inventors: Mehmet Akif Gulsun, Lawrenceville, NJ (US); Ralph Strecker, Erlangen (DE); Glenn A. Meredith, Freehold, NJ (US); Ihab R. Kamel, Ellicott City, MD (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporation, Iselin, NJ (US)

(21) Appl. No.: 12/751,086

(22) Filed: Mar. 31, 2010

Related U.S. Application Data
(60) Provisional application No. 61/167,217, filed on Apr. 7, 2009.

(51) Int. Cl. G06K 9/00

(52) U.S. Cl. 382/131

(57) ABSTRACT

A method for assessing a tumor's response to therapy, includes providing images of a first study of a patient and images of a second study of the patient, the second study occurring after the first study and after the patient undergoes therapy to treat a tumor, each study comprising first and second types of functional magnetic resonance (fMR) images, performing a first registration in which the images within each study are registered, performing a second registration in which reference images from both studies are co-registered, segmenting the tumor in an image of each of the second registered studies; and determining that first and second fMR measure differences exist between the segmented tumor's of the first and second studies, the first fMR measure difference being obtained from the first type of fMR images, the second fMR measure difference being obtained from the second type of fMR images.

### CROSS-REFERENCE TO RELATED APPLICATION

This application claims the benefit of U.S. Provisional Application No. 61/167,217, filed Apr. 7, 2009, the disclosure of which is incorporated by reference herein in its entirety.

### BACKGROUND OF THE INVENTION

1. Technical Field

The present invention relates to determining therapeutic response of a tumor by using medical imaging technologies.

2. Discussion of the Related Art

The assessment of a tumor's response to therapy plays an important role in guiding further treatments. This assessment often involves the comparison of pre-treatment and post-treatment studies. For example, if the comparison indicates that a tumor is not showing a response, further treatment might be prescribed. If the tumor is showing a response, it might be better not to treat the tumor again, to avoid the risk of side effects. If some regions of the tumor have responded and others have not, it might be advantageous to focus further treatment on the non-responding regions.

The measurement of a tumor's response at the early stages, e.g., up to four to six weeks after therapy, is important to the prescription of further treatments. The assessment of the therapeutic response as soon as possible is advantageous, since earlier decisions with regard to additional therapy can increase the chances of limiting tumor growth.

The RECIST (Response Evaluation Criteria in Solid Tumors) criteria have been the gold standard for determining therapeutic response of a tumor. The RECIST criteria define a partial response as a ≧30% decrease in diameter in a single dimension. However, the RECIST criteria might not detect the therapeutic response and thus become a poor indicator when the tumor responds at the cellular level and does not exhibit any significant change in size in the early stages after therapy.

Functional Magnetic Resonance Imaging (fMRI) techniques such as diffusion weighted imaging (DWI) and dynamic contrast enhancement (DCE) imaging are more sensitive indicators of therapeutic response of a tumor. For example, by using a functional imaging approach, it is possible to detect changes in the cellular structure of a tumor at a much earlier stage in comparison to the time it takes to detect a change in the size of the tumor. Functional imaging can also give a good assessment of the therapeutic response on a regional basis within the tumor.

Current practices assess a tumor's response to therapy by comparing pre-treatment and follow-up studies with a side-by-side analysis or separate tools. In such methods, measurements of tumor size, apparent diffusion coefficient (ADC) characteristics and perfusion are performed manually, and visual comparisons are made across serial examinations. However, these processes are time consuming, inherently subjective, and may result in an inaccurate assessment. Further, current practices do not systematically address the regional nature of a tumor's response. Further, a lack of integrated software makes the assessment time consuming and inaccurate for a combined analysis involving multiple fMRI techniques.

Accordingly, there is a need for an accurate and expeditious way of assessing a tumor's response to therapy.

### SUMMARY OF THE INVENTION

Exemplary embodiments of the present invention provide a method and system for assessing a tumor's response to therapy.

The embodiments may provide/receive images of a first study of a patient and images of a second study of the patient, the second study occurring after the first study and after the patient undergoes first therapy to treat a tumor, the images of each study comprising first and second types of functional magnetic resonance (fMR) images, a first registration may be performed in which images within each study are registered using a reference image in their respective study such that all of the first and second types of fMR images are in a common frame of reference and are anatomically aligned, a second registration may be performed in which the reference images from both studies are co-registered, wherein an operation resulting from the co-registration is applied to all images of the second study, the tumor in an image of each of the second registered studies may be segmented, and it may then be determined that first and second fMR measure differences exist between the segmented tumor's of the first and second studies, the first fMR measure difference being obtained from the first type of fMR images, the second fMR measure difference being obtained from the second type of fMR images, the determination being enabled by the second registration.

The first study may occur prior to the patient undergoing therapy to treat the tumor. The first study may take place after the patient undergoes therapy to treat the tumor but before the first therapy.

The second registration may include a deformable registration or an affine registration, the deformable registration producing a deformation field to be applied to all images of the second study, the affine registration producing an affine transformation to be applied to all images of the second study.

The embodiments may further generate a parametric map of the tumor's viability by using, in a voxel-by-voxel calculation, functional measures of the segmented tumor in the first type of fMR images of the first and second studies, and functional measures of the segmented tumor in the second type of fMR images of the first and second studies, and a weighting of each functional measure.

The embodiments may further display the map with scaled colorizations, the map being overlaid on grayscale images of one of the first or second types of fMR images.

The weighting of each functional measure may be adjusted per one or more of the following image quality metrics: signal to noise ratio, contrast to noise ratio, goodness of fit parameters, signal intensity error of prediction, consistency of the functional measure within a segmented region and consistency of the functional measure over a temporal range.

The images of the first type of fMR image may include dynamic contrast enhancement (DCE) images and the images of the second type of fMR may include diffusion weighted images.

The first fMR measure difference may be obtained by calculating arterial or venous enhancement values on a voxel-by-voxel basis for each of the segmented tumor of the second study and the segmented tumor of the first study in corresponding DCE images and identifying differences in the arterial or venous enhancement values.

The second cellular difference may be obtained by calculating differences in apparent diffusion coefficient (ADC) values on a voxel-by-voxel basis between the segmented tumor of the second study and the segmented tumor of the first study in corresponding diffusion weighted images.

The embodiments may further display individual fMR measure difference maps with colorized regions of increased, decreased or unchanged levels, or display individual fMR measure difference data as scatter plots of increased, decreased or unchanged levels overlaid on grayscale images of one of the first or second types of fMR images.

### BRIEF DESCRIPTION OF THE DRAWINGS

FIG. 1 is a flow diagram of a method for assessing a tumor's response to therapy according to an exemplary embodiment of the present invention;

FIG. 2 is a flow diagram of a registration process according to an exemplary embodiment of the present invention;

FIG. 3 includes before and after images of the registration process in FIG. 2;

FIGS. 4A and 4B include images illustrating a segmentation process and the results of the segmentation process according to an exemplary embodiment of the present invention;

FIG. 5 is an image and a scatter plot illustrating apparent diffusion coefficient (ADC) analysis according to an exemplary embodiment of the present invention;

FIG. 6 is a pair of images illustrating dynamic contrast enhancement (DCE) image analysis according to an exemplary embodiment of the present invention; and

FIG. 7 is a block diagram of a system in which exemplary embodiments of the present invention may be implemented.

### DETAILED DESCRIPTION OF EXEMPLARY EMBODIMENTS

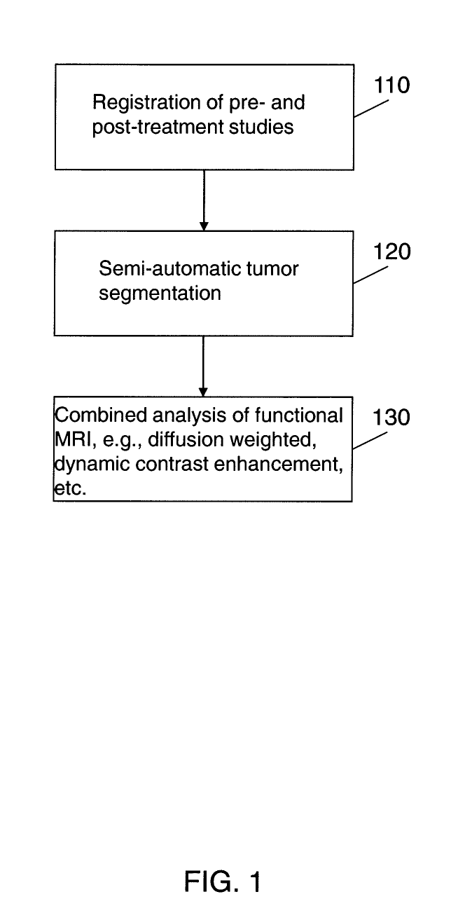

FIG. 1 is a flow diagram of a method for assessing a tumor's response to therapy according to an exemplary embodiment of the present invention. As shown in FIG. 1, pre- and post-treatment studies (each including image data of a patient) are registered (110), a tumor is segmented from the co-registered pre- and post-treatment studies (120), and then, multi-parametric analysis is performed on a regional basis (130).

This method provides a rapid solution by incorporating an integrated automated registration between pre-treatment and follow-up studies, with an integrated semi-automatic segmentation and combined analysis of multi-functional Magnetic Resonance Imaging (MRI). The automated nature of the registration improves the objectivity of the assessment. For example, the precise nature of this registration workflow provides a level of accuracy that allows voxel-by-voxel analysis when tumor size remains constant between pre- and post-treatment studies, as is commonly the case in an early post-treatment study. This accuracy and the voxel-by-voxel capability allow regional analysis that can be an important factor in the refinement of subsequent therapy.

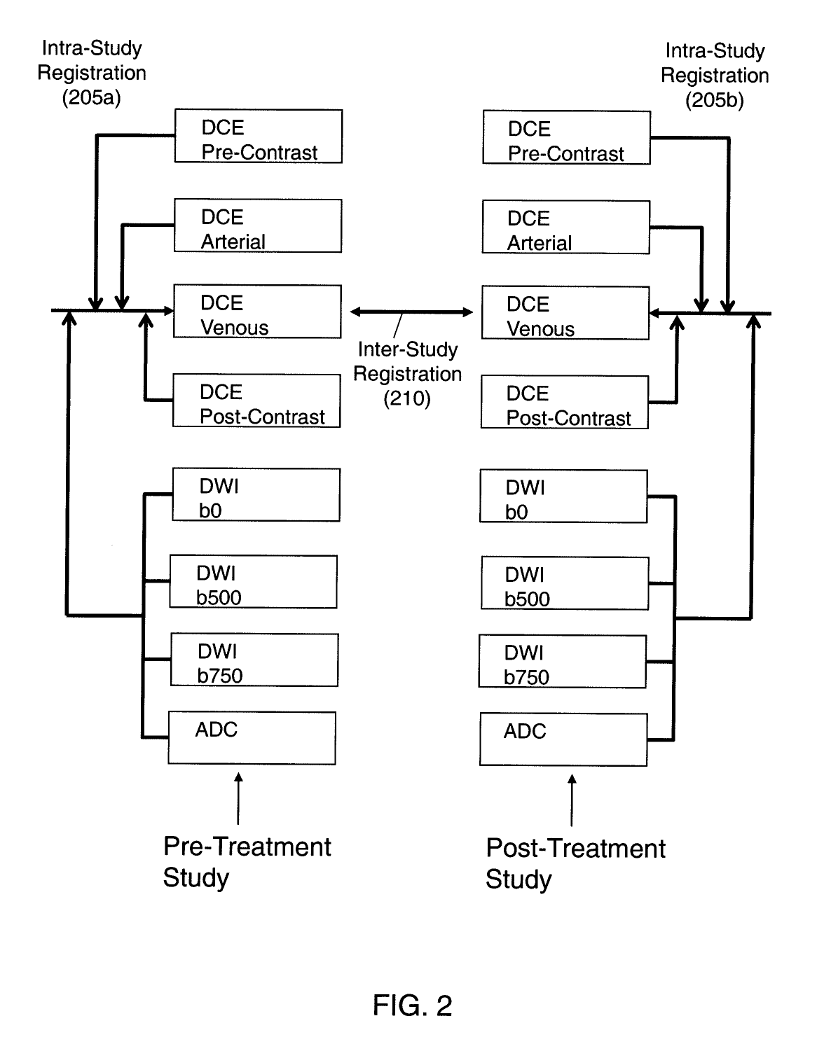

As mentioned above, a feature of the present invention is the automated registration of images in pre- and post-treatment studies, since this feature allows all images to be analyzed in a common frame of reference. The registration process happens in two steps as shown in FIG. 2: intra-study registration (205a/b) and inter-study registration (210).

In the first step, intra-study registration (205a/b), images within each study are registered using a user-selected volume, such as the venous phase post-contrast dynamic contrast enhancement (DCE) volume, as the reference image set. Motion is corrected in the DCE images (e.g., DCE Pre-Contrast, DCE Arterial and DCE Post-Contrast), where motion correction is a form of deformable registration to compensate for movement of the anatomy over the course of multiple scans of the same basic type. The diffusion weighted images (e.g., DWI b0, DWI b500 and DWI b750) and apparent diffusion coefficient (ADC) maps are a different type, but they are all acquired during the same scan and as such do not have the same need for motion correction. However, the DWI images do need to be registered to the DCE volume by using a deformable or affine registration technique that may be user-selected. The deformable registration technique first aligns the images with a rigid method to improve the capture range and accuracy, and then works with a multi-resolution strategy focusing on global and local image features at different resolution levels. The affine registration technique includes linear transformations, such as translation, rotation and scaling, which are applied in a global manner without regard to local geometric differences.

In the second step, inter-study registration (210), the venous phase DCE images, or other user-selected reference, from both studies are co-registered, and the resulting deformation field or affine transformation is applied to all images in the post-treatment study.

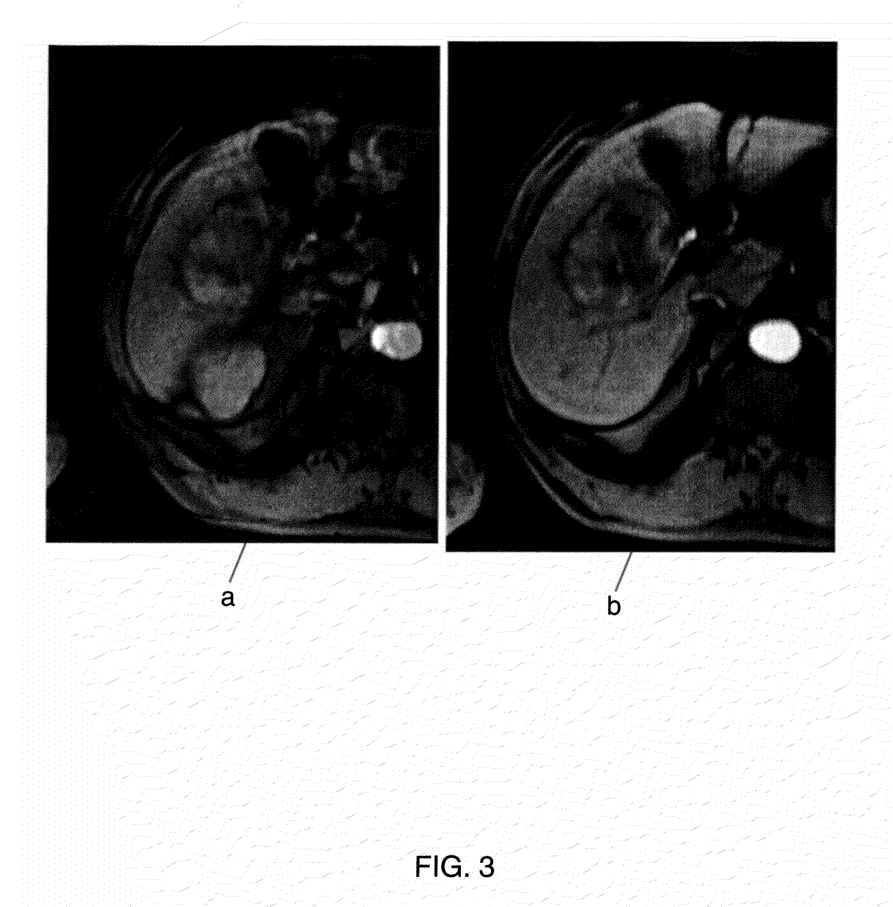

FIG. 3 is a color-blended display of pre- and post-treatment venous phase DCE images before (a) and after registration (b). As can be seen in image (a) of FIG. 3, the anatomical features are not aligned between the pre- and post-treatment images, giving the blended display a blurry appearance. In image (b) of FIG. 3, the anatomical features are aligned, making the blended display much sharper.

The ADC maps are usually generated as part of the diffusion imaging output from the scanner, as produced from the set of DWI images of different b values. All of the DWI images and the ADC maps are inherently in the same frame of reference, without any need for registration among them, even though the entire set of DWI and ADC from a study will still need to be registered with the DCE data. While the analysis stage in the exemplary embodiment focuses on the ADC maps as one of the primary measures, the DWI images are still useful in the embodiment as they usually show the anatomy more clearly than the ADC maps and thus offer better possibilities for a good registration. The ADC maps tend to be more speckled making them less suitable for registration.

It is to be understood that although DCE and diffusion weighted images are used in the example above, other functional image types may be used as well. The inclusion of more than two functional imaging techniques requires additional registration steps, as it is required that the end result of the registration workflow will be that all datasets among both studies will be in the same alignment in terms of motion of the anatomy and in the same frame of reference. Beyond the registration workflow, the inclusion of additional imaging techniques would involve additional steps in the analysis stage, with further measures being incorporated into the multiple regression, as will be described below.

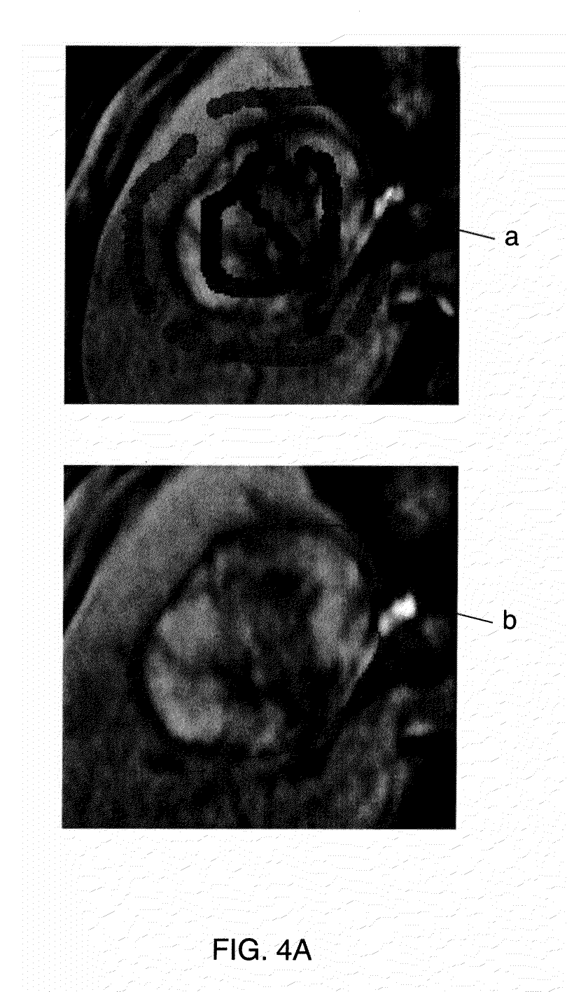

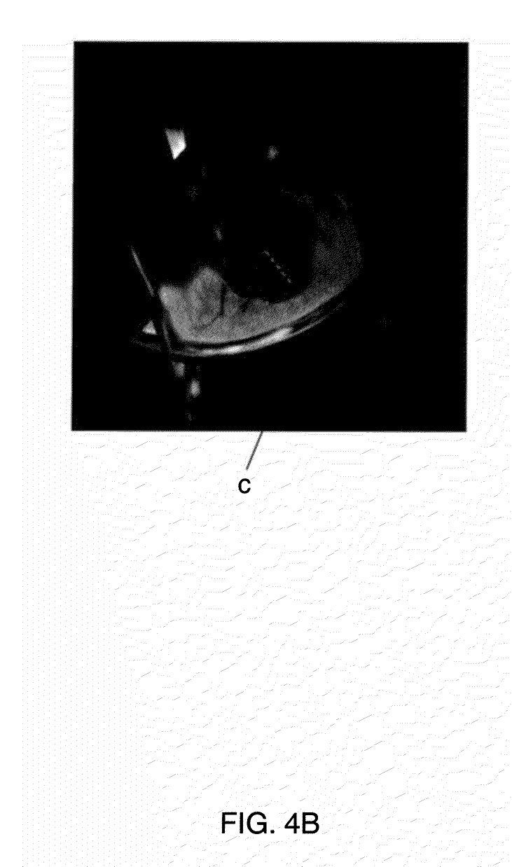

Upon completion of the registration process (e.g., step 110 of FIG. 1), a “Random Walker” three-dimensional (3D) segmentation technique is used to define the borders of the tumor. This segmentation is done on one volume in each study. That could be the reference volume as was used in the registration, or it could be any other volume in the study since they are all registered within the study at that point. The choice of volume to use for segmentation depends on which dataset most clearly shows the tumor boundary. The semi-automated “Random Walker” method requires manual placement of seed points that correspond to the tumor and surrounding tissue. For example, as shown in FIG. 4A, the center circle with a slash through the middle in image (a) identifies seeds points of the tumor and the circle surrounding the center circle in image (a) identifies seed points of tissue surrounding the tumor. This technique produces a unique solution without any assumptions or adaptive knowledge, and is capable of accurately localizing weak boundaries despite missing boundary information. After automatically segmenting the target tumor volume from any DCE or diffusion weighted image, the results can be given additional seed points or they can be edited manually with a paint feature, for example.

Results of the segmentation can be displayed in two-dimensions (2D) on multiplanar reformatted images as intersection boundaries or in three-dimensions (3D) as a surface mesh. Image (b) of FIG. 4A shows the result of segmenting the tumor in image (a) of FIG. 4A in 2D and image (c) of FIG. 4B shows the segmentation result in 3D, for example.

There is another exemplary segmentation workflow in which the segmentation done on the pre-treatment study could be mapped over to the post-treatment study. In this case, if the tumor volume has not changed, the user may decide that the mapped segmentation is acceptable for the post-treatment study as well. If it were decided that the mapped segmentation is not acceptable, then the user would have the option to edit the mapping or do a new segmentation on the post-treatment volume.

Another feature of the invention is the integration of two or more functional MR techniques, or “measures,” in the analysis such that the analysis becomes multi-parametric. Here, each functional MR measure addresses a unique physiological aspect of the tumor's response. For example, increases in ADC values computed from DWI images may indicate increased cellular necrosis, as the diffusivity is higher where the cellular walls have broken down. Decreases in DCE (% enhancement in arterial and venous phases) in the DCE images may indicate increased cellular necrosis, as the blood supply has been reduced.

By integrating both of these measures to form a multi-parametric analysis, the assessment is strengthened by the correlation of the two. For example, an increased ADC and a lower DCE may be a strong indication of necrosis, whereas a decreased ADC and a higher DCE may be a strong indication of a more viable or growing tumor, since the tumor cells become denser and have more blood supply as the capillaries continue to grow. Beyond these basic relationships, the analysis can incorporate additional factors and weighting schemes to improve the automated assessment. Further, by having a multi-parametric analysis, the assessment of the response in each region is made with a higher degree of confidence, particularly with small regions where there is a limited amount of data available from just a single measure.

Beyond the increased accuracy inherent in the multi-parametric analysis, the automated nature of the whole method, with less user input being required to perform the assessment, will improve repeatability (the variability of measurements obtained by one user operating on the same data) and the reproducibility (the variability of measurements obtained by multiple users operating on the same data).

Having such a combined analysis of functional MR imaging helps clinicians make a better decision on further treatments at an early stage even if the tumor has not changed in size. Beyond getting an indication before the size has changed, sometimes one measure will give an indication while another measure will not, in which case there is a benefit in using a multi-parametric approach. For instance, an increase in DCE and an unchanged ADC can still be a sign of tumor progress even if no change in its size is observed. This could be an important factor on the effectiveness of the therapy before the tumor starts to grow, as would be expected to eventually happen in this example.

Once the images are registered and the tumor is segmented (e.g., after the completion of steps 110 and 120 in FIG. 1), the following may be evaluated: a) volumetric data (including tumor volume, surface area and longest diameter), b) ADC values, and c) DCE in multiple vascular phases. The two studies can be compared to each other using percentage volume or on a voxel-by-voxel basis. To more visually and intuitively present the trends and relationships during the data analysis, the invention utilizes color maps and scatter plots. These representations are derived from a voxel-by-voxel comparison, in which the voxels are classified in three different groups based on threshold criteria; red for increased values, blue for decreased values and green for intermediate values. The color map presents these classified ranges on a voxel-by-voxel basis as displayed in the image frame of reference, providing valuable detail in the regional differences in the data. The corresponding scatter plot, where each point corresponds to one voxel in the tumor and is colored based on the change, uses the same classified data to provide a visual representation of the frequency and magnitude trends in the values to better assess overall changes in ADC/DCE values.

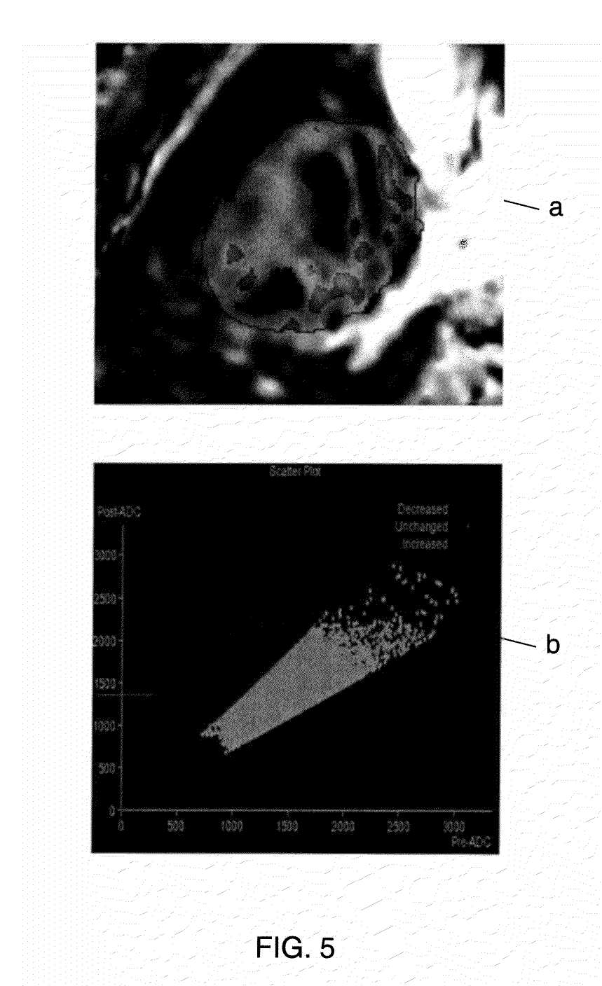

An example of this is shown in FIG. 5, with image (a) showing a color map of changes in ADC overlaid on an ADC image and image (b) showing a scatter plot. Since FIG. 5 is not in color, the darkly shaded parts of the scatter plot and the color map of the tumor correspond to the color blue, the lightly shaded parts of the scatter plot and the color map of the tumor correspond to the color green and the intermediately shaded parts of the scatter plot and the color map of the tumor correspond to the color red.

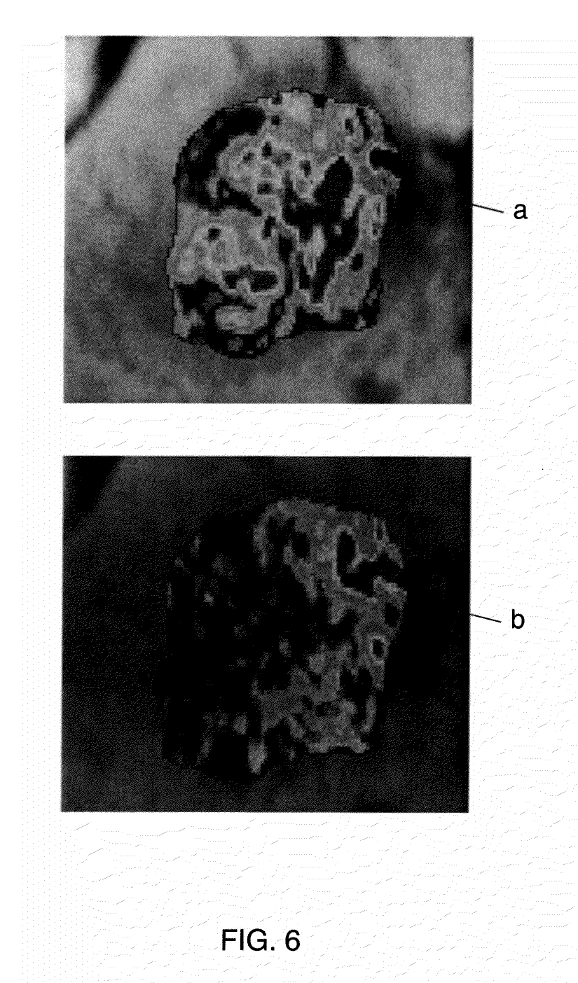

Data presentation in the invention is highly flexible. For example, histograms as well as more conventional mean, standard deviation and median values can be produced for each parameter measured. Color maps of ADC and DCE analysis can be overlaid on any image from both studies, and direct comparison becomes possible between overlaid ADC and DCE analysis. An example of this is shown by image (a) of FIG. 5 and by images (a) and (b) of FIG. 6. For instance, images (a) and (b) of FIG. 6 respectively show pre- and post-treatment arterial enhancement color maps overlaid on arterial phase DCE images. Enhancement increases from blue to red, with green being intermediate. Similar to FIG. 5, since FIG. 6 is not in color the darkly shaded parts of the tumor correspond to the color blue, the lightly shaded parts of the tumor correspond to the color green and the intermediately shaded parts correspond to the color red. Through use of such overlaid images, more than one segmented region can be evaluated at the same time. For example, the tumor in one region can be compared to healthy tissue in another region.

As illustrated in the example figures referenced above, the invention allows for making a functional analysis by comparing parametric maps of ADC and DCE between studies. Calculating changes in ADC and DCE values between studies and visualizing them as color maps allows for making a more informed decision on necrotic and viable tumor regions. Further, correlation between ADC and DCE changes can be a strong indicator to assess the treatment response. It is certainly advantageous to be able to make a voxel-by-voxel comparison of tumors between studies. It is the co-registration from the initial step that allows the voxel-by-voxel comparison between parametric images, which in turn allows the classification into different categories representing increased, decreased or intermediate values. Ultimately, this classification enables the visualization techniques of scatter plots and color maps. While scatter plots provide an overall assessment of changes in the tumor, the color maps as overlaid on real data slices give a better idea about treatment response of different regions of the tumor.

With these color maps and scatter plots, the invention makes it possible for the user to view the results of the ADC and DCE analyses separately, and to make direct comparisons between volumes as they have been registered to the same frame of reference. The user can relate these measures visually, taking into account the negative correlation between ADC and DCE, i.e., as one increases the other usually decreases and vice versa.

The next step in the method comes in drawing upon the correlation between these measures of tumor response to give the user a more automated answer to the overall question of how viable the tumor is. While the images and their associated parametric measures represent a snapshot in time, and each measure gives a part of the picture, the degree of tumor viability is a less concrete notion, and can be considered to be more of a prediction. In this sense, the analysis becomes a multiple regression problem wherein we have two predictor variables, ADC and percent enhancement, both of which affect the dependent variable, tumor viability. Given the multiple fMR measures of tumor response, the real prediction that is desired is whether the tumor will continue to grow and progress in a certain region and beyond.

One example of how the multiple regression problem can be stated is as follows:

Tumor Viability=ΔADC*weight_ADC+ΔPercent Arterial Enhancement*weight_percent_arterial_enhancement+ΔPercent Venous Enhancement*weight_percent_venous_enhancement

For additional fMR measures, additional terms would be added to the regression. The weight terms are based on a number of factors related to each measure, such as the following:
weight_ADC: adjusted per a similarity metric, relating how consistent the diffusivity measure is within the tumor region; adjusted per the signal to noise ratio in the original DWI b-value images; adjusted per the characteristics of the DWI pulse sequence in use;
weight_percent_(arterial/venous)_enhancement: adjusted per characteristics of the enhancement-variance dynamics (i.e., essentially how clearly the DCE images indicate a smooth perfusion curve from which the percent of enhancement can be calculated); adjusted per the signal to noise ratio in the original DCE images; adjusted per the characteristics of the DCE pulse sequence in use.

These weights are also analogous to the correlation coefficients for each measure in relation to tumor viability, and as such are signed values. The invention supports adjustment of these weights as user-defined parameters, with options to automate the calculation of the weights using the available data.

Using the above multiple regression model, the invention is able to produce a tumor viability map for the complete volume, by going through the pre- and post-treatment data of multiple functional imaging techniques on a voxel-by-voxel basis. The tumor viability map can then be displayed with scaled colorizations, indicating the degree of viability voxel-by-voxel overlaid on the grayscale images of one of the functional types, similar to the data presentations described earlier for the individual measures.

The strength of this multi-parametric analysis relates back to the correlation between variables. Just as there is correlation between ADC and DCE, there are also correlations between ADC and tumor viability, and between DCE and tumor viability. Given that there is some degree of independence between ADC and DCE, the “multiple correlation coefficient” which relates the dependent variable (tumor viability) to the predictor variables (ADC and percent enhancement) will have a greater value (closer to 1.0 or to −1.0), as compared to either of the individual predictor correlation coefficients. This greater value for the multiple correlation coefficient implies a more accurate assessment. Beyond this increase in accuracy, by having the overall tumor viability assessment calculated automatically and presented graphically, the user can rapidly see which regions show strong indications and can then refer back to the individual measure analyses to better understand the mechanisms for the tumor response.

Once the regions of different levels of therapy response have been identified by the multi-parametric analysis, the user is better able to focus on the areas of importance using tools for 3D visualization, including maximum intensity projection, volume rendering techniques and 3D multi-planar reformat rendering modes for visualizing an entire volume, and tools for measurement, including distance and pixel lens tools. Such tools can enhance the multi-parametric analysis of a tumor's response to therapy.

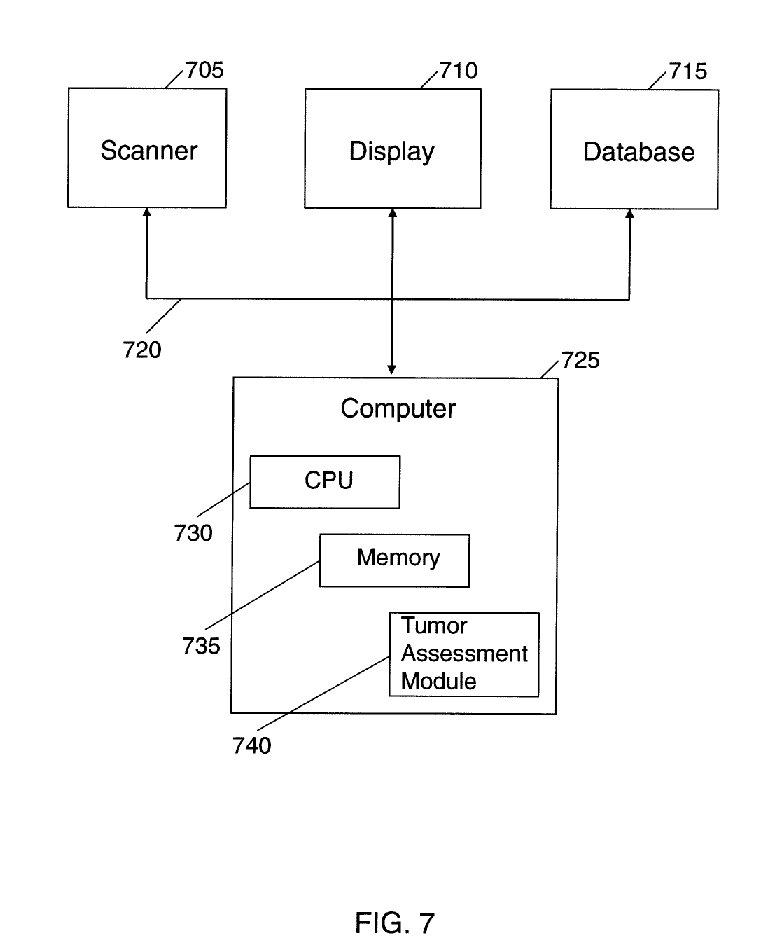

A system in which exemplary embodiments of the present invention may be implemented will now be described with reference to FIG. 7. As shown in FIG. 7, the system includes a scanner 705, a display 710, a database 715 and a computer 725 connected over a wired or wireless network 720. The scanner 705 may be an MR or other type of scanner that is capable of functional imaging, for example. Image data acquired by the scanner 705 may be provided directly to the computer 725, or it may be provided directly to the database 715 for subsequent access by the computer 725, for example. The computer 725 includes, inter alia, a central processing unit (CPU) 730, a memory 735 and a tumor assessment module 740 that includes program code for executing methods in accordance with exemplary embodiments of the present invention. The display 710 may be a liquid crystal display (LCD) type computer screen, for example.

In an exemplary embodiment, the present invention may be implemented in software as an application program tangibly embodied on a program storage device (e.g., magnetic floppy disk, random access memory (RAM), compact disk read only memory (CD ROM), digital video disk (DVD), ROM, and flash memory). The application program may be uploaded to, and executed by, a machine comprising any suitable architecture.

It is to be understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

While the present invention has been described in detail with reference to exemplary embodiments thereof, those skilled in the art will appreciate that various modifications and substitutions can be made thereto without departing from the spirit and scope of the present invention as set forth in the appended claims.

What is claimed is:

1. A method for assessing a tumor's response to therapy, comprising:
providing images of a first study of a patient and images of a second study of the patient, the second study occurring after the first study and after the patient undergoes first therapy to treat a tumor, each study comprising first and second types of functional magnetic resonance (fMR) images;
performing a first registration in which the images within each study are registered such that all of the first and second types of fMR images are in a common frame of reference and anatomically aligned;
performing a second registration in which reference images from both studies are co-registered, wherein an operation resulting from the co-registration is applied to all images of the second study;
segmenting the tumor in an image of each of the second registered studies; and
determining that first and second fMR measure differences exist between the segmented tumor of the first study and the segmented tumor of the second study, the first fMR measure difference being obtained from the first type of fMR images, the second fMR measure difference being obtained from the second type of fMR images, the determination being enabled by the second registration.

2. The method of claim 1, wherein the first study occurs prior to the patient undergoing therapy to treat the tumor.

3. The method of claim 1, wherein the first study takes place after the patient undergoes therapy to treat the tumor but before the first therapy.

4. The method of claim 1, wherein the second registration comprises a deformable registration or an affine registration, the deformable registration producing a deformation field to be applied to all images of the second study, the affine registration producing an affine transformation to be applied to all images of the second study.

5. The method of claim 1, further comprising generating a parametric map of the tumor's viability by using, in a voxel-by-voxel calculation, functional measures of the segmented tumor in the first type of fMR images of the first and second studies, and functional measures of the segmented tumor in the second type of fMR images of the first and second studies, and a weighting of each functional measure.

6. The method of claim 5, further comprising displaying the map with scaled colorizations, the map being overlaid on grayscale images of one of the first or second types of fMR images.

7. The method of claim 5, wherein the weighting of each functional measure is adjusted per one or more of the following image quality metrics: signal to noise ratio, contrast to noise ratio, goodness of fit parameters, signal intensity error of prediction, consistency of the functional measure within a segmented region and consistency of the functional measure over a temporal range.

8. The method of claim 1, wherein the first type of fMR images comprise dynamic contrast enhancement (DCE) images and the second type of fMR images comprise diffusion weighted images.

9. The method of claim 8, wherein the first fMR measure difference is obtained by calculating arterial or venous enhancement values on a voxel-by-voxel basis for each of the segmented tumor of the second study and the segmented tumor of the first study in corresponding DCE images and identifying differences in the arterial or venous enhancement values.

10. The method of claim 8, wherein the second cellular difference is obtained by calculating differences in apparent diffusion coefficient (ADC) values on a voxel-by-voxel basis between the segmented tumor of the second study and the segmented tumor of the first study in corresponding diffusion weighted images.

11. The method of claim 1, further comprising displaying individual fMR measure difference maps with colorized regions of increased, decreased or unchanged levels, or displaying individual fMR measure difference data as scatter plots of increased, decreased or unchanged levels overlaid on grayscale images of one of the first or second types of fMR images.

12. A system for assessing a tumor's response to therapy, comprising:
a memory device for storing a program:
a processor in communication with the memory device, the processor operative with the program to:
receive images of a first study of a patient and images of a second study of the patient, the second study occurring after the first study and after the patient undergoes first therapy to treat a tumor, each study comprising first and second types of functional magnetic resonance (fMR) images;
perform a first registration in which the images within each study are registered such that all of the first and second types of fMR images are in a common frame of reference and anatomically aligned;
perform a second registration in which reference images from both studies are co-registered, wherein an operation resulting from the co-registration is applied to all images of the second study;
segment the tumor in an image of each of the second registered studies; and
determine that first and second fMR measure differences exist between the segmented tumor of the first study and the segmented tumor of the second study, the first fMR measure difference being obtained from the first type of fMR images, the second fMR measure difference being obtained from the second type of fMR images, the determination being enabled by the second registration.

13. The system of claim 12, wherein the first study occurs prior to the patient undergoing therapy to treat the tumor.

14. The system of claim 12, wherein the first study takes place after the patient undergoes therapy to treat the tumor but before the first therapy.

15. The system of claim 12, wherein the second registration comprises a deformable registration or an affine registration, the deformable registration producing a deformation field to be applied to all images of the second study, and the affine registration producing an affine transformation to be applied to all images of the second study.

16. The system of claim 12, wherein the processor is further operative with the program to generate a parametric map of the tumor's viability by using, in a voxel-by-voxel calculation, functional measures of the segmented tumor in the first type of fMR images of the first and second studies, and functional measures of the segmented tumor in the second type of fMR images of the first and second studies, and a weighting of each functional measure.

17. The system of claim 16, wherein the processor is further operative with the program to display the map with scaled colorizations, displaying individual fMR measure difference maps with colorized regions of increased, decreased or unchanged levels, or displaying individual fMR measure difference data as scatter plots of increased, decreased or unchanged levels.

18. The system of claim 16, wherein the weighting of each functional measure is adjusted per one or more of the following image quality metrics: signal to noise ratio, contrast to noise ratio, goodness of fit parameters, signal intensity error of prediction, consistency of the functional measure within a segmented region and consistency of the functional measure over a temporal range.

19. The system of claim 12, wherein the first type of fMR images comprise dynamic contrast enhancement (DCE) images and the second type of fMR images comprise diffusion weighted images.

20. The system of claim 19, wherein the first fMR measure difference is obtained by calculating arterial or venous enhancement values on a voxel-by-voxel basis for each of the segmented tumor of the second study and the segmented tumor of the first study in corresponding DCE images and identifying differences in the arterial or venous enhancement values.

21. The system of claim 19, wherein the second cellular difference is obtained by calculating differences in apparent diffusion coefficient (ADC) values on a voxel-by-voxel basis between the segmented tumor of the second study and the segmented tumor of the first study in corresponding diffusion weighted images.

22. The system of claim 12, wherein the processor is further operative with the program to display individual fMR measure difference maps with colorized regions of increased, decreased or unchanged levels, or displaying individual fMR measure difference data as scatter plots of increased, decreased or unchanged levels overlaid on grayscale images of one of the first or second types of fMR images.
